(19) United States
(12) Patent Application Publication
(10) Pub. No.: US 2011/0202398 A1
(43) Pub. Date: Aug. 18, 2011

(54) PERSONAL PLANNER WITH TARGETED ADVERTISING

(76) Inventor: Sarah Photowat, Great Falls, VA (US)

(21) Appl. No.: 12/705,850

(22) Filed: Feb. 15, 2010

(51) Int. Cl. G06Q 30/00

(52) U.S. Cl. 705/14.5

(57) ABSTRACT

A computerized system for generating a visual presentation for visually organizing one or more planned future activities of a user. The system presents a time line for each one of potentially several aspects of the user's life, an icon for selecting one or more time lines, and at least one advisory icon which displays advertiser content related to commercial goods or services pertaining to a future activity. The advisory icon may contain data transmitted over the internet from a web source of the vendor of the commercial good or service. The system may display recommended details of a future activity, such as a checklist of details of conducting a wedding, thereby serving as a reminder. The system may apply a filter function to eliminate some vendors from consideration due for example to excessive distance from the activity. Life aspects may include vocation, house, automobiles, children, education, pregnancy, and social occasions.

### FIELD OF THE INVENTION

The present invention relates to computerized personal planning systems providing a graphical output format, and more particularly to a computerized personal planning system which displays prequalified potential commercial sources of potential goods and services, each displayed at an appropriate place in the graphical output.

### BACKGROUND OF THE INVENTION

The complexity of modern life may be attenuated by the use of suitable planning systems to enable people to organize and plan future events. Both routine and extraordinary events may be assisted by a suitable planning system. Some people keep lists to serve as reminders. Others mark calendars to similar effect. However, being in fixed form, paper based planning and reminder systems are subject to inability to accommodate changes, additions, deletions, and similar modifications.

Planning systems are typically based on data entered by the user or operator of the system, and cannot accept inputs from outside sources or second parties. Sometimes, the second parties with whom the user will interact may have inputs to the interaction which are potentially of interest to the user of the system. The user must typically make an on-the-spot decision to include these inputs or to dismiss these second parties.

Many digital reminder systems cannot accept inputs, such as advertisements, from second parties. The numbers and identities of potential suppliers of goods and services for upcoming events may be limited to those known to the user, with more suitable suppliers being ignored.

Many digital planning systems cannot discriminate among or prequalify potential suppliers of goods and services so that those presented by the system are the most suitable.

Many planning systems cannot contribute to planning by the user.

There exists a need for a dynamic planning system which can actively identify suitable suppliers of goods and services, which can assist in organizing or planning an upcoming event, and which most successfully links a person who may be overwhelmed with the details of planning one or more events with truly helpful suppliers.

### SUMMARY OF THE INVENTION

The present invention provides a computerized planning system which has the ability to match suppliers of goods and services with specific needs of users. The novel planning system can match advertising and suppliers to the actual needs of a person engaged in planning future events, and further can discriminate among potential advertisers and suppliers so that only the most suitable advertisers and suppliers are presented. This can be automatically implemented for example in the course of internet searching. This ability tends to overcome overload frequently encountered by those attempting to utilize general internet searching for vendors for example. The list of potential suppliers is automatically pared down to a useful number, and also is limited to those who will actually be helpful given constraints of time, geography, costs, and other factors.

Beyond limiting advertisers to those who will likely prove the most helpful to the person using the system, the system can contribute to planning of upcoming events, as a life advisor, so that it becomes more relied upon by users. For example, aspects of social occasions such as weddings typically entail activities which occur in many weddings. The novel system can provide predetermined listings of suggested steps and activities which would pertain to frequently encountered occasions such as for example weddings. The predetermined listing may be in checklist form and list chores such as reserving a suitable venue, ordering flowers, a wedding cake, ordering costumes, booking lodging accommodations for guests, and the like.

Because the user is spared the burden of overload, because advertisers and suppliers identified by the system are prequalified in ways useful to the user, and because the system takes on responsibility for implementing some of the planning, it becomes very attractive to utilize the novel system in planning upcoming events.

It is desirable not only to people engaged in planning, but also to vendors of goods and services to be presented to potential customers in such a targeted way. Each virtual contact is more likely to result in a sale than when appealing to the general public in an unfocussed way.

The novel system integrates preselection or prequalification of advertisers or vendors of goods and services into the graphical output of the planning process in a way that logically and unobtrusively serves the interests of the user. The graphical output may be visually linear in form, with passage of time being displayed in a way which intuitively and visually appeals to the user. The linear array of symbolic and linguistic prompts are not only visually organized, but also may be limited by the user to show only subject matter of interest. Continuing with the example of planning a wedding, the visual display may be limited to subject matter pertaining to the wedding. Alternatively, several different activities may selectively be displayed. Illustratively, for any given period of time, a first linear display may graphically indicate actions which must be undertaken regarding an upcoming wedding, with graphic symbols or icons or textual message displayed along the time line. Below or beside the first time line, a second time line may be displayed which indicates actions which must be undertaken regarding the user's job. This job time line can be supplemented by integrating the user's workplace generated calendar of events. Below or beside the second time line a third time line may be displayed which indicates actions which must be undertaken regarding maintenance and other tasks regarding the user's house. The three time lines may cover the same time period, such as a particular calendar month.

For each time line, the user may conduct internet research in an effort to identify suitable or desirable service or goods suppliers. The novel system may automatically or by affirmative action on the user's part filter what would otherwise be virtually unlimited search results. For example, suppliers may be discriminated on the basis of geographic proximity to the user's house, to the user's place of work, or to the site of an upcoming social occasion such as a wedding. Other forms of discrimination are possible. For example, those suppliers advertising sales or issuing or recognizing coupons may be reported exclusively, or emphasized graphically even when joined by other suppliers not offering inducements such as sales or coupon usage. Still other discriminations may be based on professional and commercial affiliations, prior experience on the part of the user, or for still other reasons.

A resulting graphic display of results may be manipulated as desired by the user, for example, to show only one time line, to be limited to a particular time period such as one week following the current day, to show more details such as location, hours, and contact information for each of the proposed suppliers, and in other ways.

In summary, the user may therefore visually organize aspects of one upcoming event or may coordinate one upcoming event with additional upcoming events.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 shows a representative screen display depicting planned events or activities arranged along time lines, in addition to other features.

FIG. 2 shows a representative screen display similar to FIG. 1, but showing additional time lines.

FIG. 3 shows a representative screen display depicting commands which may be used to categorize on-line advertisers and to generate content displays based on advertising content.

FIG. 4 shows a representative screen display depicting elements of FIG. 3, but including additional display options.

FIG. 5 shows an alternative display format which may be used to display subject matter which could be displayed using the format of FIG. 1.

FIG. 6 shows a further alternative display format which may be used to display subject matter which could be displayed using the format of FIG. 1.

FIG. 7 shows a still further alternative display format which may be used to display subject matter which could be displayed using the format of FIG. 1.

### DETAILED DESCRIPTION

The present invention is a system or method of generating a visual presentation which is functional to visually organize and present in graphic form planned future activities of a user of the system or method, arranged along a time line. The system can also store and past events of the user. The system or method may display subordinate aspects of the planned future activities, and may identify vendors of goods, services, or both goods and services for supporting the planned future activities. The invention may be thought of both as a method, which comprises steps to be described hereinafter, or alternatively as a system, which comprises a data processor and associated peripherals, and programming capable of implementing the steps of the method. The physical apparatus may comprise for example a processor such as a personal computer, a visual output such as a display screen or computer monitor, a human-machine-interface (ex. mobile device), and conventional connection apparatus for communicating to the internet. The human-machine-interface may comprise a keyboard, a computer mouse, a joystick, integrated or separate touchscreen, any other physically manipulated device for entering commands into the processor, or any combination of these. As the physical apparatus of the system may be conventional in physical form and in function, apart from programming which implements the steps of the method, the physical apparatus need not be described in detail.

The invention is best explained with reference to images which may appear on the visual output element of the processor, such as a monitor or other display screen. It will be understood that succeeding images or screens may be navigated in conventional fashion.

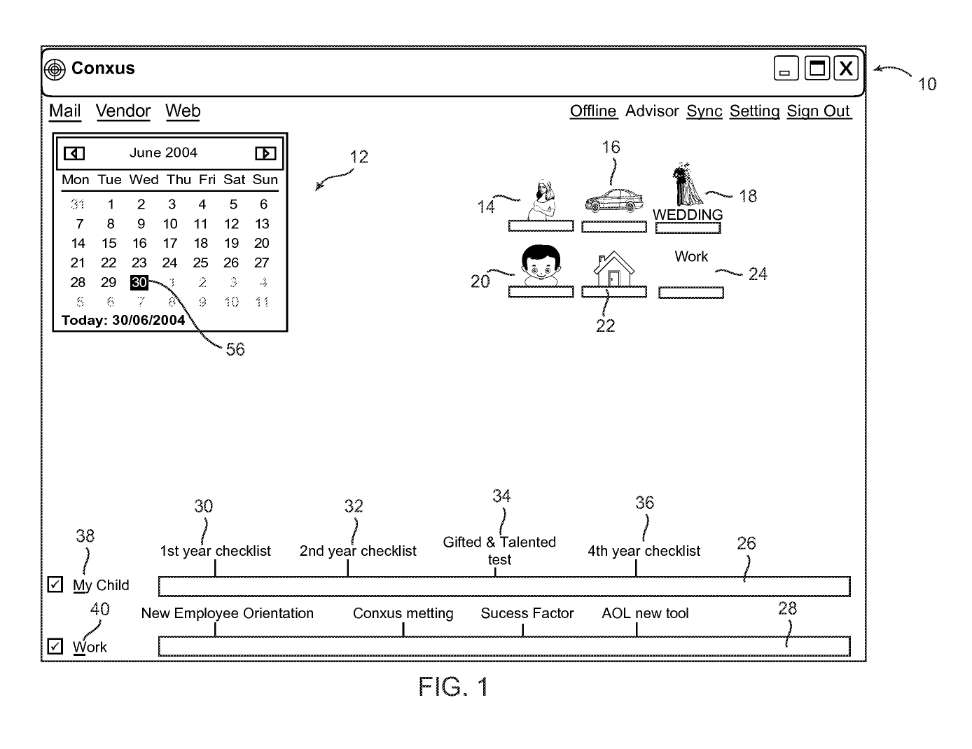

Referring first to FIG. 1, there is shown a screen 10 which is representative of screens which may be used to implement the novel method. It should be understood that the screen 10 and other screens illustrated herein provide examples for purposes of explaining the invention, and should not be construed in a limiting sense. The screen 10 may depict a representation of a one month calendar 12, any number of subject matter selection icons such as the six selection icons 14, 16, 18, 20, 22, 24, and at least one time line such as the two time lines 26, 28. The subject matter selection icons each represent a different time line.

Each time line 26 or 28 is in the form of a serial visual element such as a horizontal bar. Each time line such as the time lines 26, 28 pertain to one aspect of the life of the user, the subject matter of each being different from that of every other time line. In the examples presented herein, the time line 26 is directed to a child of the user; the time line 28 is directed to the work or job of the user; a time line 42 is directed to the house or other residence or property of the user; a time line 44 is related to a pregnancy of a member of the social circle of the user; a time line 46 is related to an automobile or other motor vehicle of the user; and a time line 48 is related to a social occasion to be undertaken within the social circle of the user, and more specifically, a wedding of a member of the social circle of the user. In most cases, the social circle of the user will be a family member, but may of course be friends and other associates of the user.

Legends such as the legends 30, 32, 34, 36 may appear proximate the bar of a time line such as the time line 26. These legends 30, 32, 34, 36 may be connected to their associated bar with location along the time line 26 being in serial relation to indicate the order in which the subject matter is to be addressed. Alternatively stated, location of the time line icon along the time line represents a point in time when a specific subordinate activity or aspect of the general activity or aspect of life represented by that particular time line is to be addressed by the person using the screen 10 and associated method of generating a visual presentation. Location of events called out by legends such as the legends 30, 32, 34, 36 may be arbitrarily spaced apart along the time line 26, such as evenly spaced apart, or alternatively may be spaced apart in a manner reflecting proportionality of magnitude of time intervals intended to occur between events called out by the legends.

Regardless of the selected form, legends or other graphical device provide a plurality of time line icons disposed along the time line display, wherein each time line icon, such as the time line icons 30, 32, 34, 36, represents a subordinate aspect pertaining to the planned future activity. In the example of the time line 26, the planned future activity is those activities which pertain to a child, this being indicated by the legend or indicia 38. Similarly, the legend 40 indicates that the second time line 28 actively being displayed is that pertaining to the work or vocation of the user.

In the screen 10, two time lines 26, 28 are active, or are being displayed. Other time lines (not shown) may be stored in memory and may be summoned by invoking appropriate ones of the selection icons 14, 16, 18, 20, 22, 24. Any number of time lines may be made active at the user's discretion. Time lines such as the time lines 26, 28 may be activated or deactivated by for example clicking on the appropriate selection icon 14, 16, 18, 20, 22, or 24 using a computer mouse associated with the processor.

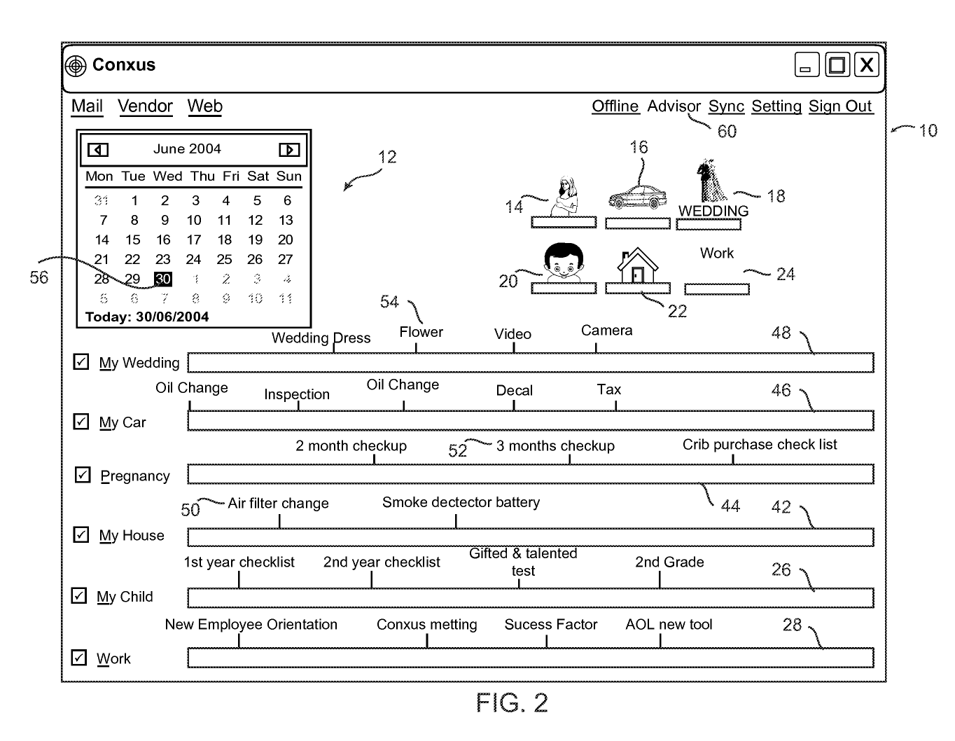

FIG. 2 shows a new screen 41 in which additional time lines 42, 44, 46, 48 being active in addition to the time lines 26, 28 of the screen 10 of FIG. 1. The additional time lines 42, 44, 46, 48 each have respective time line icons such as the time line icons 50, 52, 54, to name but a representative few. The management programming which administers the novel method or system is functional to selectively display and conceal or cancel any of the time lines by user manipulation of the human-machine-interface, such as by clicking on a predetermined symbol, such as the selection icons 14, 16, 18, 20, 22, 24 displayed on the display screen using a computer mouse. Control of the number of time lines displayed, such as the time lines 26, 28, 42, 44, 46, 48, is therefore in the hands of the user. Fewer active time lines, such as seen in FIG. 1, will reduce visual clutter of the screen 10. More active time lines, displayed simultaneously, such as seen in FIG. 2, will maximize the number of aspects of life to be planned. This latter feature may be useful for example in identifying potential scheduling or other conflicts.

The calendar 12 may display the current month or may be linked to a selected date to show the full month for a month other than the current month. The current day may be highlighted or otherwise emphasized, as exemplified by the solid background 56.

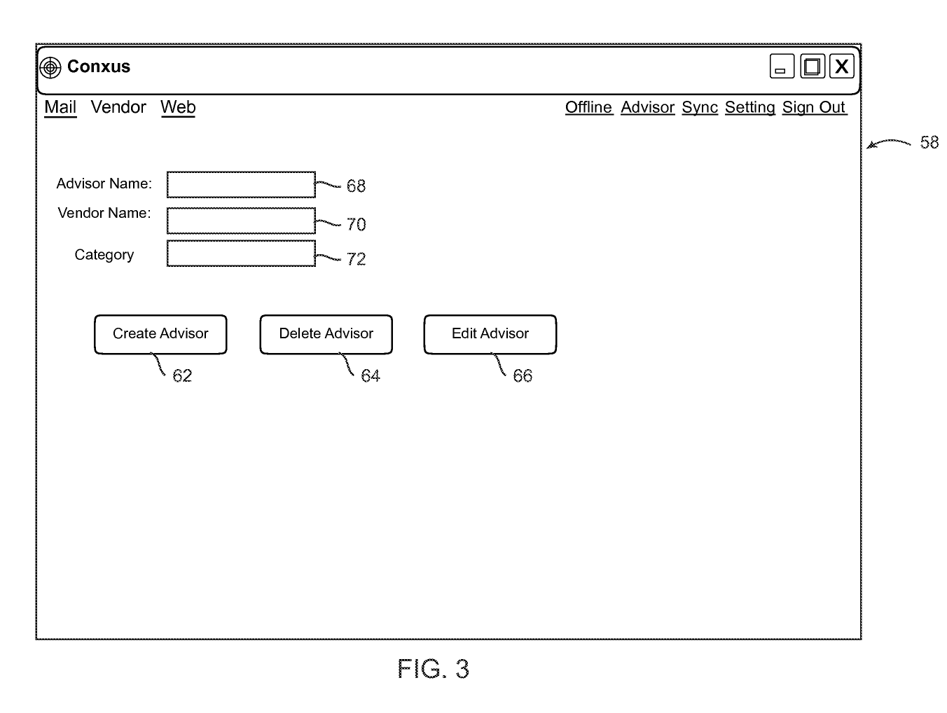

Turning now to FIG. 3, the novel system contemplates provision of at least one advisory icon. A new screen 58 has been generated for example by clicking on the “Advisor” icon 60 of FIG. 2. With calendar 12, selection icons 14, 16, 18, 20, 22, 24, and time lines 26, 28, 42, 44, 46, 48 omitted for visual clarity, the screen 58 shows a command icon 62 for creating an advisory icon, a command icon 64 for deleting an advisory icon, and a command icon 66 for editing a created advisory icon. Fillable spaces 68, 70, 72 are provided respectively, for entering the identity of a commercial vendor of goods or services or both, the actual name of the vendor, and which category or identity will be used with this vendor. Vendors are selected from among those who are pre-approved by a host provider (or not) and provide information from a web source, and who commercially offer goods or services to the general public. In conducting general internet searching, the user may limit vendors to those offering goods and services which pertain to the subordinate aspect of the planned future activity. The resulting advisory icon contains data corresponding to advertising content, which is transmitted over the internet from the web source. Any number of advisory icons may be generated in this manner. Advisory icons may be linked to the subject matter of any selected time line, such as the time line 26.

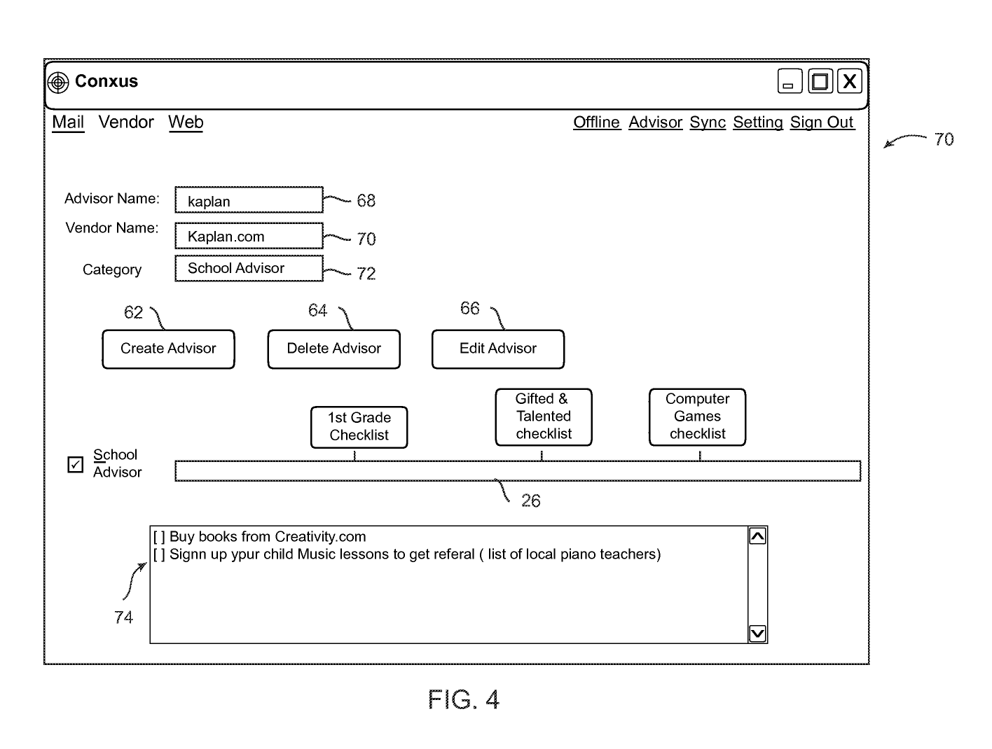

FIG. 4 shows a screen 70 generally corresponding to the screen 58 of FIG. 3, but differing in that it is also populated by the time line 26, pertaining to a child. It will be seen that the user has entered into the fillable space 68 a vendor known as “kaplan”, the formal name used on the internet by this vendor being “Kaplan.com”, entered into the fillable space 70, and a category of “school advisor” having been entered into the fillable space 72. An advertiser can cooperate with other advertisers to cross brand each other's goods. For example, Kaplan.com could provide information for a related vendor such as Creativity.com and vice versa.

Below the time line 26 appears two legends 74 which offer the user goods, services, and proposed events or items. These goods and services are offered by the vendor Kaplan.com. The legends 74 are automatically generated when that vendor is summoned using an advisory icon which has been generated using the command icon 62. The management programming of the novel method and system is functional to display at least one of the advisory icons by clicking on a predetermined symbol displayed on the display screen, such as the advisor icon 60 (see FIG. 2) using the computer mouse.

Part of the process of generating the legends 74, which may be regarded as an advisory icon, is a screening process in which the management programming which has been entered into the processor to administer the novel method is functional to apply predetermined acceptance criteria to the advisory icons. Predetermined acceptance criteria may include determination of geographic proximity of vendors to the premises to be used by the user in engaging in a planned future activity and other qualifications which may be selected by the user or provided by the management programming or both. Other criteria may include cost and price considerations, delivery or lead time for goods and services, and the nature of specialized products, to name but a few. The concept of the advisory icon tailors vendors to the personal situation of the user of the novel system.

The preceding disclosure can be visualized by the advisor linking the user with the appropriate vendor, USER→ADVISOR←VENDOR. It also contemplated that additional modes of information transfer can be achieved between the parties other than that shown above, for example a vendor may receive usable information from the user as the user completes its time line.

Potential vendors who fail to meet the acceptance criteria are inhibited from participation in the advisory icons. This elimination of many potential vendors results in qualification of a pool of potential vendors who meet criteria desirable to the user; thereby improving the search experience of the user.

It will be seen from FIG. 4 that the time line display, the time line icons, and the advisory icon are all displayed simultaneously on the screen 70 or other visual output.

The management programming which administers the novel method and system is functional to generate, display, delete, and conceal any of the advisory icons by user manipulation of the human-machine-interface.

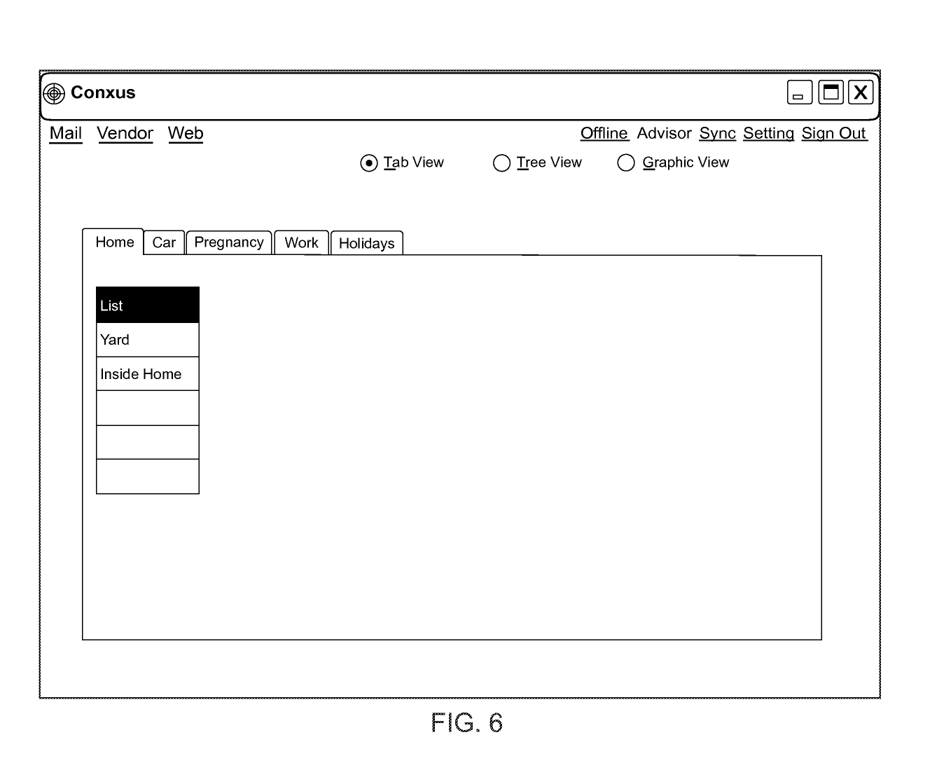

The invention may be thought of as a method of generating subject matter such as the content of the screens shown in FIGS. 1-7. The method may comprise a step of providing a data processor having a visual output, a human-machine interface, and an internet connection, and a step of providing management programming loaded into the data processor, which management programming is disposed to generate a display on the visual output of the data processor, wherein the visual output comprises a time line display comprising at least one serial visual element representing at least one time line comprising a time interval during which at least one planned future activity is to be performed, and at least one advisory icon, wherein the advisory icon displays a commercial offering of at least one of a publicly available commercial good or a publicly available commercial service pertaining to the subordinate aspect of the planned future activity, wherein the subject matter of the advisory icon contains data transmitted over the internet from a web source of the vendor of the commercial good or commercial service.

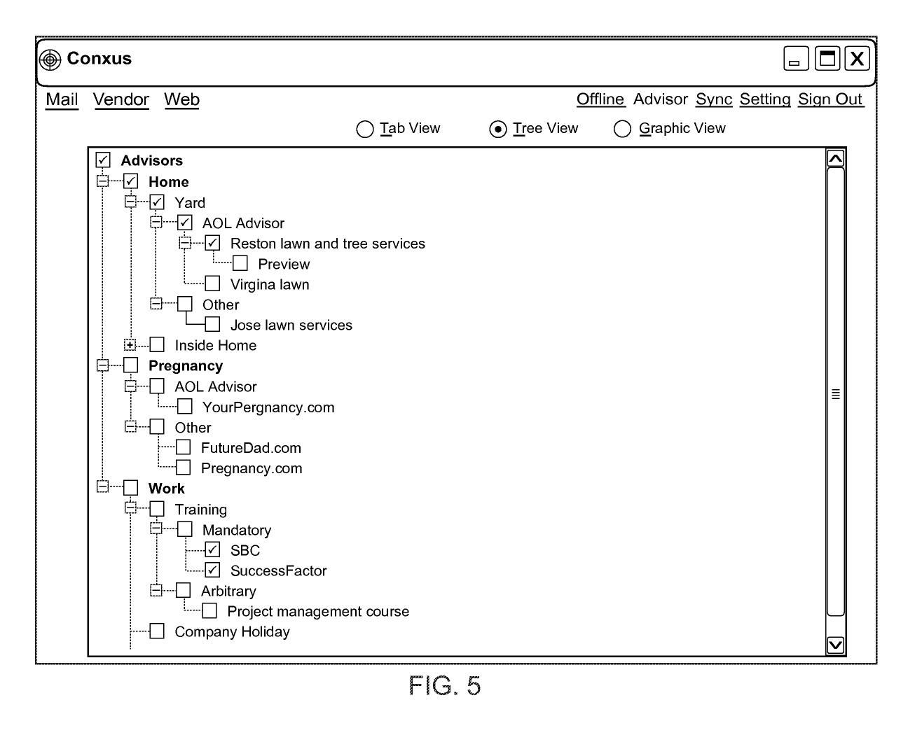

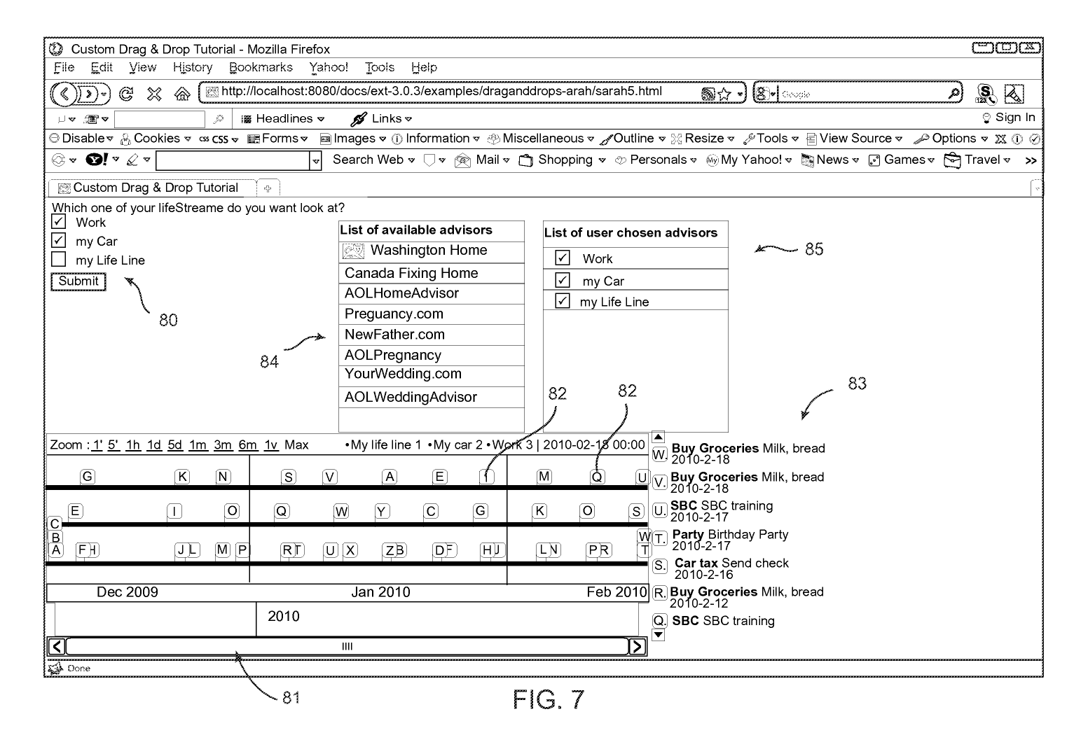

The format of visual effects such as time lines may be varied. FIGS. 5, 6, and 7 each show an alternative format for displaying subject matter shown in the prior Figures. In particular with FIG. 7, some additional functional aspects are present. For example, the user is able to select which time lines from the list of chosen time lines it would like to display by “checking” the boxes 80 (or the boxes located on the time line 85) next to the representative time lines they would like to display. This allows the user to integrate different time line together into a time line summary 81. When a number of timelines are integrated, the time line summary may include reference symbols 82 to represent a particular event is taking place at a particular time in the time line summary. The reference symbols are then defined in an alternate portion in the form of a “key” 83 so that the complete event descriptions, which correspond to a reference symbol, can be shown more clearly. As also shown in FIG. 7, the user is able to select which time lines it would like to add to his/her life by selecting from all available time lines 84. Furthermore, the user can display or hide and web host generated time lines 85.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A method of generating a visual presentation which is functional to visually organize and present planned future activities of a user of the method, to display subordinate aspects of the planned future activities, and to identify vendors of goods, services, or both goods and services for supporting the planned future activities, comprising the steps of:
providing a data processor having a visual output, a human-machine interface, and an internet connection; and
providing management programming loaded into the data processor, which management programming is disposed to generate a display on the visual output of the data processor, wherein the visual output comprises
a time line display comprising at least one serial visual element representing at least one time line comprising a time interval during which at least one planned future activity is to be performed,
a plurality of time line icons disposed along the time line display, wherein each time line icon represents a subordinate aspect pertaining to the planned future activity, and location of the time line icon along the time line represents a time when the subordinate aspect is to be addressed by the person using the method, and
at least one advisory icon, wherein the advisory icon displays a commercial offering of at least one of a publicly available commercial good or a publicly available commercial service pertaining to the subordinate aspect of the planned future activity, wherein the subject matter of the advisory icon contains data transmitted over the internet from a web source of the vendor of the commercial good or commercial service.

2. The method of claim 2, wherein the time line display, the time line icons, and the advisory icon are all displayed simultaneously on the visual output.

3. The method of claim 2, wherein the visual output also displays a representation of a calendar.

4. The method of claim 1, wherein the time line display comprises a plurality of time lines each pertaining to subject matter different from that of every other time line.

5. The method of claim 1, wherein the visual output is an image disposed on a display screen associated with the data processor.

6. The method of claim 4, wherein the management programming is functional to selectively display and conceal any of the time lines by user manipulation of the human-machine-interface.

7. The method of claim 1, wherein the management programming is functional to display and conceal any of the advisory icons by user manipulation of the human-machine-interface.

8. The method of claim 7, wherein the human-machine-interface comprises a computer mouse or mobile device, the visual output comprises a monitor having a display screen, and the management programming is functional to display at least one of the advisory icons by clicking on a predetermined symbol displayed on the display screen using the computer mouse or mobile device.

9. The method of claim 1, wherein
the human-machine-interface comprises a computer mouse or mobile device,
the visual output comprises a monitor having a display screen which presents a screen image which displays at least one time line and a plurality of subject matter selection icons each representing a different time line, and
time lines may be selectively activated and canceled by clicking on a predetermined symbol displayed on the display screen using the computer mouse.

10. The method of claim 9, wherein plural time lines may be displayed simultaneously.

11. The method of claim 1, wherein the management program is functional to generate at least one advisory icon, delete a generated advisory icon, display a generated advisory icon on the visual output, and remove a generated advisory icon from display on the visual output by manipulation of the human-machine-interface.

12. The method of claim 1, wherein the management program is functional to apply predetermined acceptance criteria to the advisory icons, whereby potential vendors who fail to meet the acceptance criteria are inhibited from participation in the advisory icons.

13. The method of claim 12, wherein the predetermined acceptance criteria comprises a predetermined geographic proximity of vendors to the premises to be used by the user in engaging in a planned future activity.

14. The method of claim 1, wherein one time line is dedicated to activities pertaining to the work of the user of the method.

15. The method of claim 1, wherein one time line is dedicated to activities pertaining to the residence of the user of the method.

16. The method of claim 1, wherein one time line is dedicated to activities pertaining to at least one motor vehicle used by the user.

17. The method of claim 1, wherein one time line is dedicated to activities pertaining to at least one child of the user.

18. The method of claim 1, wherein one time line is dedicated to activities pertaining to a pregnancy in the social circle of the user.

19. The method of claim 1, wherein one time line is dedicated to activities pertaining to a social occasion to be undertaken by the social circle of the user.

20. The method of claim 19, wherein the social occasion is a wedding.
